(19) United States
(12) Patent Application Publication
(10) Pub. No.: US 2026/0124529 A1
(43) Pub. Date: May 7, 2026

(54) System and Method for Capacitive Sensor Powered Illuminated Floor and Wall Tiles Delivering an Interactive Game Room Experience

(71) Applicants: Yifu Huang, Whitestone, NY (US); Rui Xiong, Montclair, NJ (US)

(72) Inventors: Yifu Huang, Whitestone, NY (US); Rui Xiong, Montclair, NJ (US)

(21) Appl. No.: 18/936,265

(22) Filed: Nov. 4, 2024

(51) Int. Cl. A63F 13/25; G06F 3/044; H05B 45/20; H05B 47/115

(52) U.S. Cl. CPC A63F 13/25; G06F 3/044; H05B 45/20; H05B 47/115; G06F 2203/04108

(57) ABSTRACT

System and methods for delivering an interactive game room experience featuring illuminated floor and wall tiles equipped with capacitive sensors. These tiles activate when players come within one to two inches, eliminating the need for physical contact and reducing the risk of injury or damage associated with prior art. This innovation enhances safety and durability while maintaining high interactivity. The game room includes enclosed spaces with color-changing tiles that respond to player proximity, ensuring longevity and continuous use. Controlled by an all-in-one personal computer, the system provides game information on remote displays and manages communication between controllers, receivers, and LED tiles. Each tile features low-power RGB LED nodes in durable, water-resistant casings, ensuring efficiency and resilience. This invention provides a safe, durable, and engaging environment for immersive gaming scenarios.

### FEDERALLY SPONSORED RESEARCH

Not Applicable

### SEQUENCE LISTING OR PROGRAM

Not Applicable

### TECHNICAL FIELD OF THE INVENTION

The present invention relates generally to interactive game rooms. More specifically, the present invention relates to interactive game rooms where an enclosed room is filled with illuminated floor and wall tiles that have capacitive sensors are interacted with by users/players who respond to varied colored tiles to engage with the game room and game play experience being delivered by the room and corresponding floor and wall tiles.

### BACKGROUND OF THE INVENTION

Immersive game rooms represent an advanced form of interactive entertainment where players are transported into a highly engaging, often story-driven environment. These rooms are designed to blur the lines between the virtual and physical worlds, using a variety of technologies to create a fully immersive experience. Players can interact with the environment and each other in real-time, solving puzzles, completing tasks, and advancing through the game's narrative. The concept has gained significant popularity in recent years, driven by the demand for more engaging and memorable entertainment experiences.

Central to the functionality of immersive game rooms are advanced technologies such as light and sensor tiles or tiles. These elements are crucial in creating the interactive environments that define immersive games. Light tiles or tiles can be programmed to change colors, display patterns, or project images, enhancing the visual atmosphere and guiding players through different stages of the game. Sensor tiles or tiles, on the other hand, detect player movements, touches, and even proximity, allowing the game environment to respond dynamically to the players' actions. This combination of visual and sensory feedback plays a key role in maintaining player engagement and immersion.

The integration of light and sensor technologies in immersive game rooms has opened up new possibilities for game design and interactivity. These technologies allow for more complex and responsive game mechanics, where the environment can change in real-time based on player inputs. For instance, stepping on a specific tile might trigger a hidden door to open, or touching a panel could reveal a clue necessary for solving a puzzle. The adaptability of these technologies also means that game rooms can be easily reconfigured to offer new challenges and experiences, ensuring that players have a fresh and exciting experience each time they participate.

The present invention teaches a system and methods for delivering an interactive game room experience with illuminated floor and wall tiles that have capacitive sensors.

### SUMMARY OF THE INVENTION

The present invention introduces a system and methods for delivering an interactive game room experience featuring illuminated floor and wall tiles equipped with capacitive sensors. These tiles activate when players come within one to two inches of them, eliminating the need for physical contact and thus reducing the risk of injury or damage associated with prior art that relied on weight or force sensors. This innovative approach enhances the safety and durability of the game room environment while maintaining high levels of interactivity.

The game room described by the invention includes enclosed spaces with illuminated floor and wall tiles that change colors and respond to the proximity of players. This interaction does not require actual physical contact, as the tiles use capacitive to detect presence within a specified range. The absence of physical touch requirements not only enhances player safety but also ensures the longevity of the tiles, making them more suitable for continuous use in immersive gaming scenarios.

The hardware components of the system are controlled by an electronic device such as an all-in-one personal computer connected to a TV or other remote displays, providing game information such as levels, points, and player status. The PC also connects to a switch that manages communication and control between controllers, receivers, and the active game LED floor. Each LED tile within the floor and wall features low-power RGB LED nodes housed in durable, water-resistant casings, ensuring both efficiency and resilience in the game room environment.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates the system hardware components of the present invention.

FIG. 2 illustrates a LED tile as taught and used by the present invention.

FIG. 3 illustrates a LED tile and specific dimensions as taught and used by the present invention.

FIG. 4 illustrates the room setup of an exemplary room taught by the present invention and the hardware required to provide the interactive and immersive game experience.

FIGS. 5-8 illustrate a first room layout taught by the present invention.

FIG. 9 is a flow chart of one method of game play taught by the present invention.

FIG. 10 is a flow chart of the method for determining adverse events and success events and processing those outcomes to the gameplay and outcome.

FIG. 11 is a flow chart of the method for the calculation of adverse events and success events.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The present invention teaches a system and methods for delivering an interactive game room experience with illuminated floor and wall tiles that have capacitive sensors. The present invention utilizes floor and wall tiles which have capacitive sensors. Therefore players do not need to physically touch the panel for the activation of the sensor and the functional sensor distance is about one to two inches high. In prior art immersive and interactive game rooms, a weight or force sensor is used, which requires players to physically touch the panel, which can lead to player or panel/tile injury or damage and increases liability.

The present invention teaches an enclosed room with illuminated floor and wall tiles where players respond to varied colored tiles to engage with your game room. The tiles taught and used by the present invention are activated through proximation of players within approximately one to two inches. Although the tiles use capacitive to detect a player's present, actual physical contact is not required.

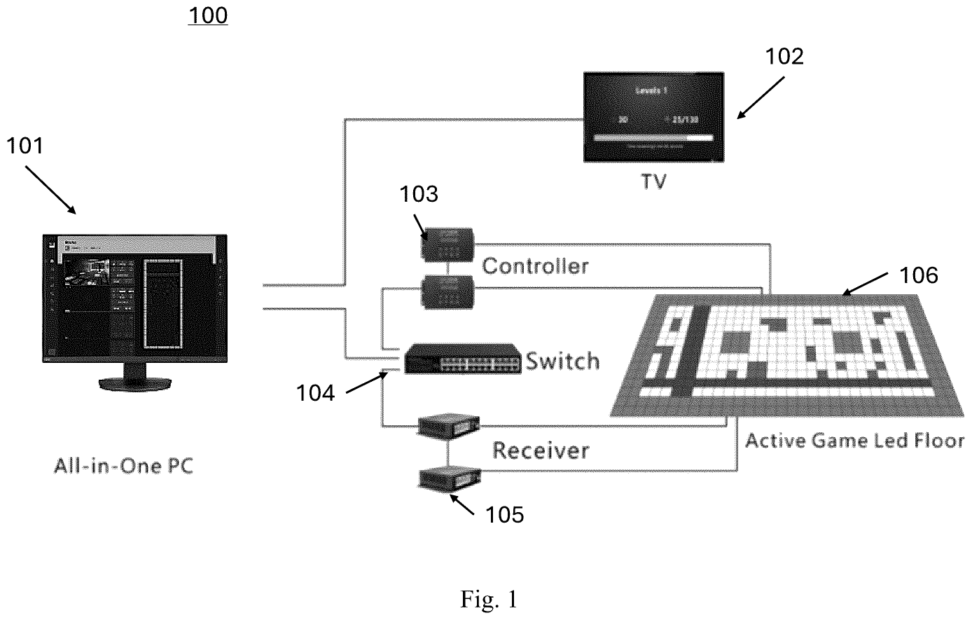

Now referring to FIGS. 1-3, the hardware components of the system for delivering the interactive game room experience and novel game play methods is illustrated.

FIG. 1 illustrates the individual hardware components 100 of the present invention. The hardware components are programmed and controlled by an electronic device such as an all-in-one personal computer (PC) 101. The PC 101 is connected to a TV or other remote display 102 that provides game information such as levels, energy/life, points, and other game specific play information and feedback. One or more displays 102 can be connected to provide for multiple in game screens as well as external displays for spectators or other team members to monitor.

The PC 101 is also connected to a switch 104. The switch 104 enables communication and controls to one or more controllers 103 and one or more receivers 105 which are both connected to the active game LED floor 106. The active game LED floor 106 is comprised of a plurality of LED tiles 200.

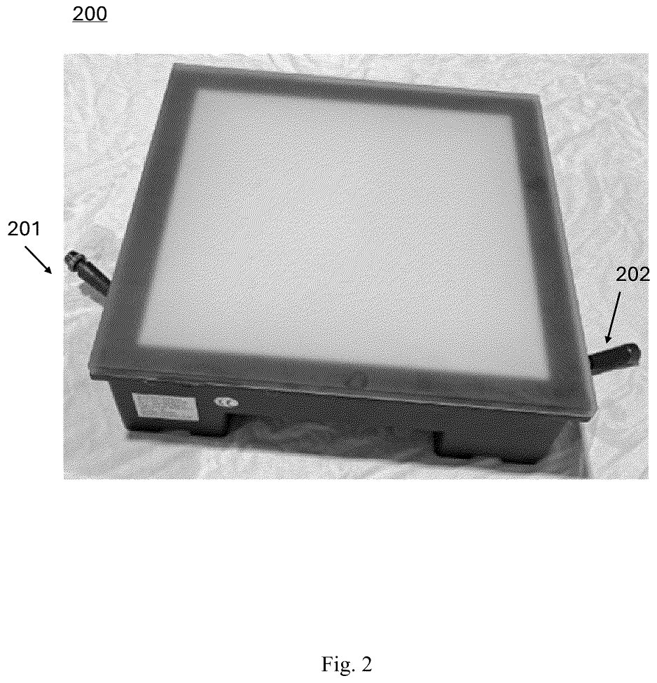

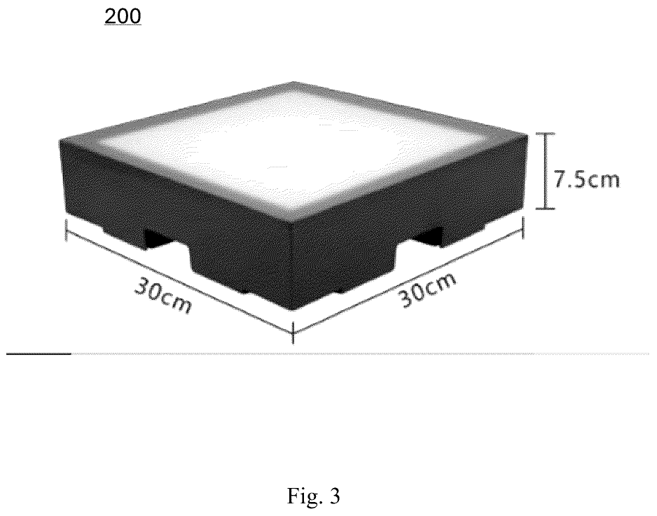

Now referring to FIGS. 2-3, a single LED tile 200 is illustrated. The LED Tile light source is based on 5050 individual small RGB LED nodes, which have specs such as low power utilization from a DC 24V input, low heat generation, high longevity, and impact resistance. The LED Tile exterior box has a molded ABS plastic housing with a 10 mm tempered glass top/exterior surface weighing 3.9 kg that is water resistance in accordance with IP65 standards. The LED Tile dimensions are 30 cm×30 cm square, and 7.5 cm in height/thickness. The LED tile 200 has an efficiency of 7W. The light size is 300 mm in length by 300 mm wide and 85 mm high/thick. The LED tile 200 also includes embedded sensors. Industry standard male connectors 201 for input and female connectors 202 for output are included on each tile.

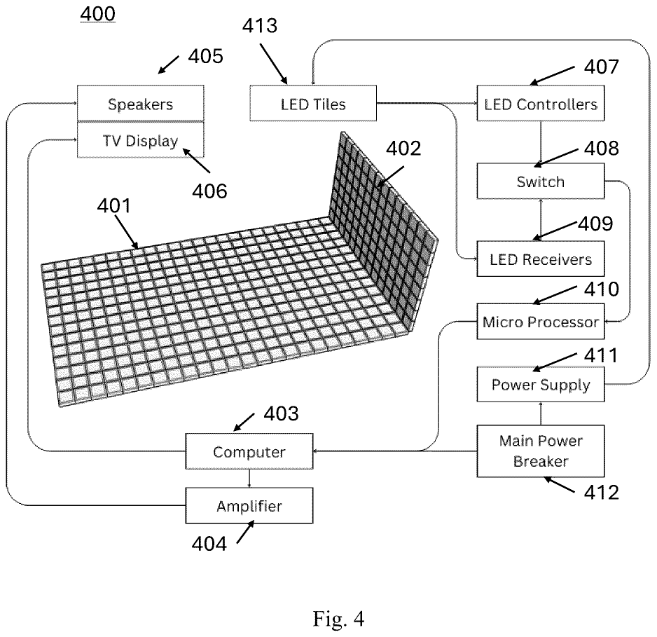

FIG. 4 illustrates an exemplary room setup 400 taught by the present invention. In this embodiment the room is comprised of a plurality of floor tiles 401 and wall tiles 402 located on one of the four walls, in a rectangular room, the tiled wall would be located on one of the shorter sides. The hardware used to control the room and corresponding floor tiles 401 and wall tiles 402 are a computer 403 connected to an amplifier 404 connected to one or more speakers 405 and a TV display 406. The computer 403 is connected to a micro processor 410 and main power breaker 412. The main power breaker 412 is connected to a power supply 411 that is connected to the LED tiles 413. The micro processor 410 is connected to the switch 404 which provides communication to the LED controllers 407 and LED receivers 409.

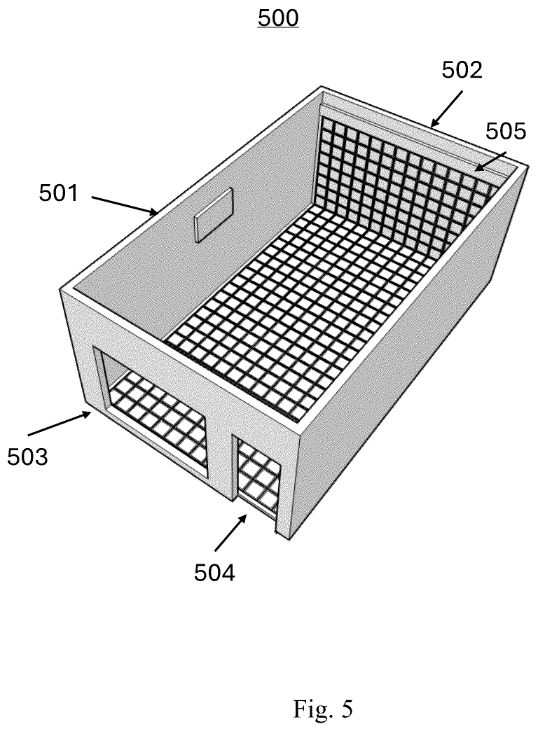

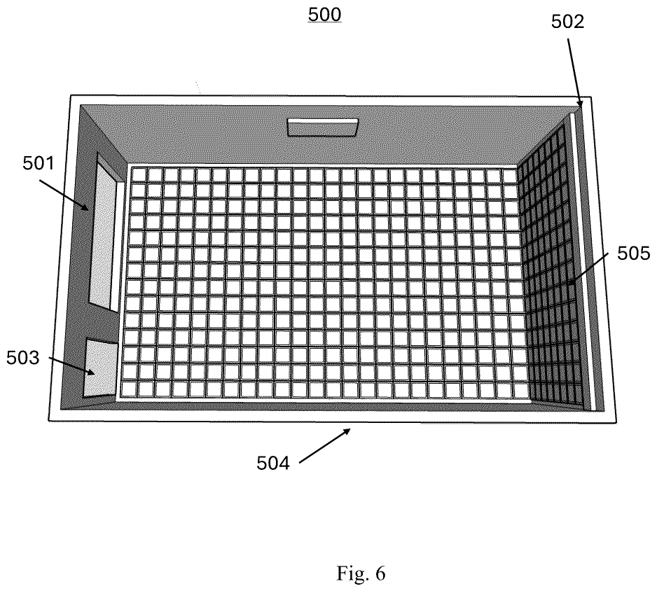

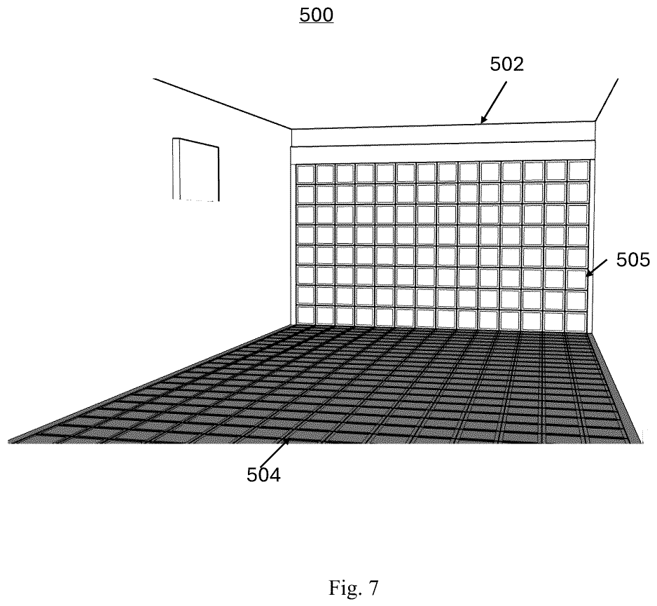

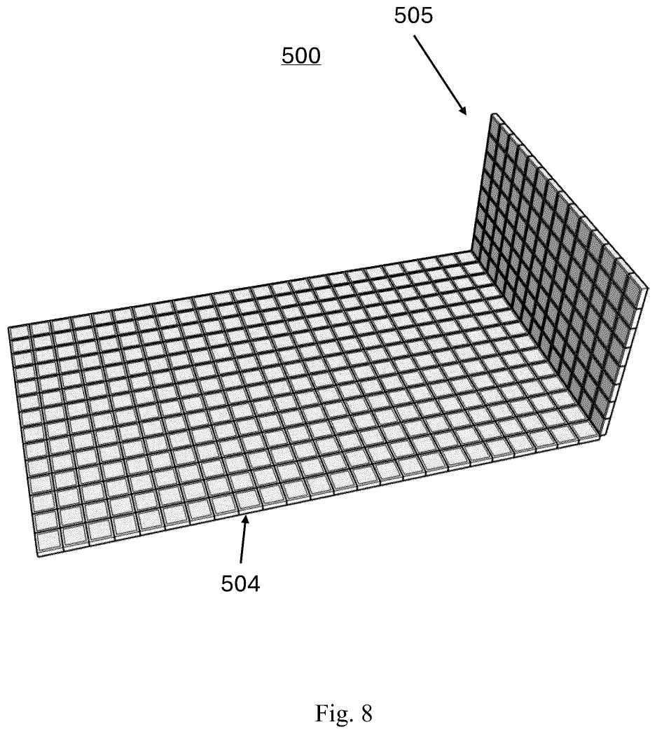

FIGS. 5-8 illustrate a first room layout taught by the present invention. Here the room is rectangular shaped 500 with the entire floor covered in floor tiles 501 and one wall, the shorter wall of the rectangular shape opposite a viewing window 503 and entrance 504 on the opposing short wall 505, having a plurality of wall tiles covering the entire wall 502.

In alternative embodiments, a 2 tiled-wall or 3 tile-wall setup is possible. In this setup the red tiles could come from left, right, and front.

Locations delivering the immersive experience will have two to five games which for example, could be 14×24 floor tiles with one 8×14 tile wall. In one embodiment of the present invention, in each of the games there will be approximately 10 levels and the customer will have 18-20 mins to complete them.

Although for some embodiments are specific on the time frame, e.g., 18-20 mins, any time frame for game play can be set or any allotted time may be used. These parameters might change in alternative embodiments. For example, in casual vs challenge game modes in alternative embodiments could have differences in levels and time.

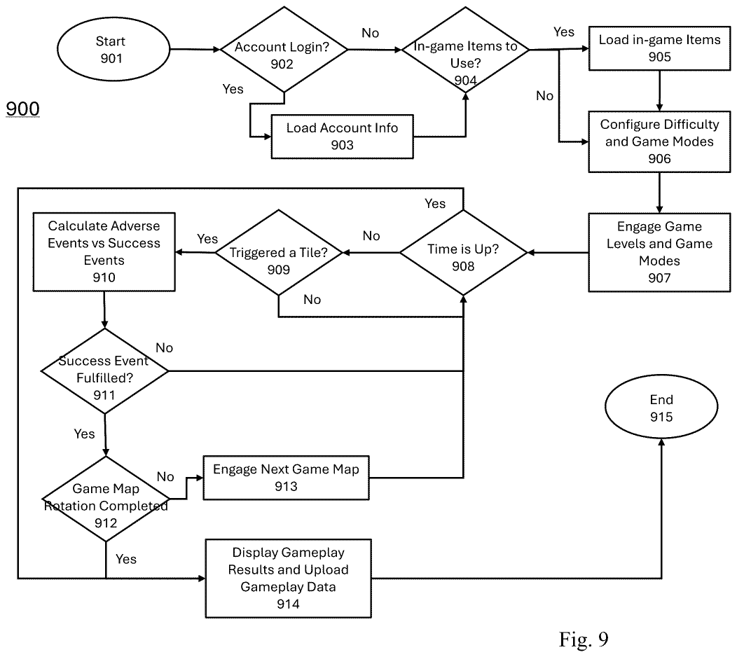

FIG. 9 is a flow chart of one method of game play 900 taught by the present invention. To start 901 a game an account login 902 is requested. If an account login 902 is provided account information is loaded 903 and a request to use in game items 904 is presented. If no account information is provided a request to use in game items 904 is presented. If in game items are available, the in-game items are loaded 905 and the ability to configure difficulty and game modes is presented 906. If not in game items are available, the ability to configure difficulty and game modes is presented 906. Next game levels and game modes are engaged 907 and play begins time is up 908. During game play and before time is up 908, the system continually monitors if a tile is triggered 909. If a tile is triggered 909 the system calculates an adverse events vs success events 910.

The system and method taught by the present invention takes adverse events into the calculation of the final score but does not actively affect or adjust gameplay. Conversely, the prior art will have adverse effects and directly affect or alter the gameplay by kicking the participating team out of the room to make way for the next team by ending the game.

Respectively, the present invention is not a true adverse event whereas the prior art takes away the playing privilege completely. The present invention teaches gameplay where a round restarts when the total life pool has been depleted.

The core concept as of now is an adverse event equals stepping on a specific colored tile, such as a red tile and a success event equals stepping on a different, second colored tile, such as a blue tile.

If a success event 911 is not fulfilled, the system checks if time is up 908 and continues to monitor for a tile triggering event 909 until time is up 908.

If a success event 911 is fulfilled, the system determines if a game map rotation has been completed 912.

For example, the present invention could have casual vs challenge map rotations where the game mechanics are all the same except the intensity or difficulty of the levels, aka map rotation. The present invention will have many “map rotations” or different rotations of game levels.

If the game map rotation is not completed, the system engages the next game map and the game continues as until time is up 908 and the process of checking for triggered tiles 909 continues until time is up 908.

If the game map rotation 912 is completed, gameplay results are displayed and the game play data is stored/uploaded 914 and the gaming session ends 915.

In general, with respect to game play, the system and method of the present invention keeps track of how many times each colored panel has been triggered. There is no penalty in triggering red tiles and red tiles do not affect the final score. In this exemplary embodiment of the present invention “red tiles” do not affect the final score but are taken into account into the ranking or scoring.

The red tiles, or any color tiles designated in the system as adverse events, get a total adverse events points pool. At the end of the game, the final results will include gameplay data that shows the total adverse events pool. It will affect ranking or scoring in the foreseeable future, but what it means to be affecting or not affecting final score is up for debate.

As previously discussed, in the game play taught by the present invention triggering the red tiles (or any designated colored tile), the present invention does not kick players out or effect the gameplay just because they used up all of their life points. The present invention wants and teaches where the scheduled time slot to be dedicated to the booking party is completely used and available to them regardless of their skill level.

The general concept of the present invention is the same, if one or more players does not meet time or life limitations, the round will restart. Future alternative embodiments will include new and alternative concepts current under evaluation and testing.

In other alternative embodiments of the present invention a game scoring algorithm to track player (individual or group) performance by tracking elements including but not limited to sequential numbers of tiles with certain properties hit, numbers of tiles with certain properties avoided, numbers of tiles hit at a particular rate per unit of time, and accounting for all of the aforementioned based on the number of players taking part in the game activity simultaneously.

A computer-based system allowing tracking of scores associated with individual user and/or group/team profiles in a persistent manner is also used. This system would allow for progression of individual players and/or teams over time, based on their performance in the game sessions and the number of sessions they had participated in, potentially also tracking the number of distinct locations in which they had participated in game sessions.

A system comprised of a web and/or smartphone application allows users to view their progression statistics and historical scores from a personal device. This system allows the users to register for future game sessions at specific locations.

The progression system connects to an associated rewards system that offered digital and/or physical rewards to players and/or teams that had reached certain milestones in progression, e.g. a certain total gameplay score over time, or a certain number of total sessions participated in, or a certain number of total distinct gameplay locations visited for a game session.

Digital rewards could include but not be limited to digital stickers which could be displayed in a “sticker book” in the system mentioned in the previous bullet point, and these stickers could potentially be traded with other players, or digital “avatars” associated with the user's profile in the broader progression system.

Physical rewards could include branded merchandise provided by the game session location, and could be exchanged for “points” accrued by players over time according to an algorithm based on various factors (lifetime gameplay point score, number of sessions, number of group sessions, total number of group session participants, total number of physical gameplay locations visited, etc.), or could simply be unlocked at various progression milestones and redeemed without needing to exchange “points”.

The points scoring system and progression systems would be used as inputs to a leaderboard system that would allow individuals and/or groups/teams to compare their performance in individual game sessions and over time against the performance of others, including against their past selves. This leaderboard system could also have associated digital and/or physical rewards as described in the prior bullet point, e.g. a reward for the best team performance over a given period of time such as a week or a month, with the ability for leaderboards to reset periodically to reset the competition between various players and/or teams.

The present invention can also incorporate a system allowing the distribution of new gameplay levels, new gameplay modes, new or updated scoring systems, and possible other game features such as new digital rewards for players to game room operators, to offer enhanced experience to players. This system would be a separate computer system to which game room operators would connect their gameplay computer systems, in order to receive updated gameplay content, features, game modes, etc.

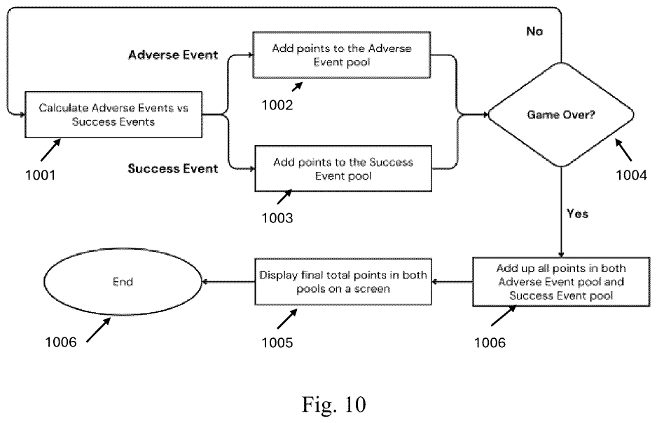

FIG. 10 is a flow chart of the method for determining adverse events and success events and processing those outcomes to the gameplay and outcome. In this exemplary embodiment, the interactive game room experience calculates adverse events and success events 1001. If an adverse event is determined, points are added to an adverse event pool 1002. If a success event is determined, points are added to a success event pool 1003. The calculation of adverse events and success events will continue until a game is over determination is made 1004. Once a game over determination 1004 is made, all points in both the adverse event pool and success event pool are added up 1006 and final total points in both pools are displayed on a screen 1005 and the interactive game room experience ends 1006.

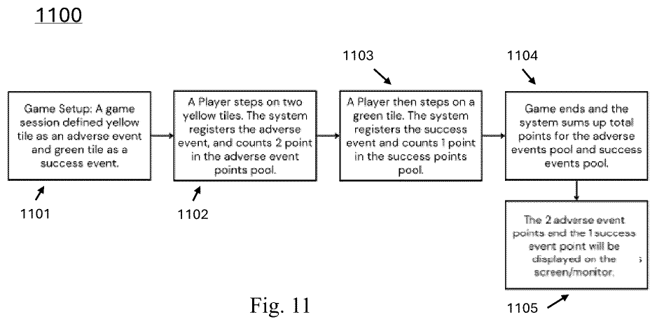

FIG. 11 is a flow chart of the method for the calculation of adverse events and success events for one exemplary embodiment of the present invention 1100. A game session first defines yellow tile as an adverse event and green tiles as a success event 1101. If a player steps on two yellow tiles, the system registers the adverse event and counts two points in the adverse event pool 1102. If a player then steps on a green tile, the system registers the success event and counts one point in the success points pool 1103. The game ends and the system sums up the total points for the adverse events pool and success events pool 1104. The two adverse event points and the one success event point will be displayed on the screen/monitor 1105.

A game engine system used for synchronized display and information feedback between the lighted tiles on the floors and wall of the game room, visual displays (e.g. television or monitor displays) to show messages and information related to the game state or various instructions related to the gameplay, an audio system (e.g. for playing music and sound effects which may be synchronized to the gameplay state), and possible other future input devices that may affect or alter the gameplay in some fashion (e.g. a control interface allowing a game room operator to alter aspects of the gameplay while a game session is active, or a control interface allowing a player who is not interacting with the lighted tiles directly to affect some behavior of the lighted tiles in the game room, etc.).

The system and method of the present invention is set to run on one or more computing devices, mobile electronic devices, or a combination thereof. A computing device or mobile electronic device on which the present invention can run would be comprised of a CPU, storage device, keyboard, monitor or screen, CPU main memory and a portion of main memory where the system resides and executes. Any general-purpose computer, smartphone, or other mobile electronic device with an appropriate amount of storage space is suitable for this purpose. Computer and mobile electronic devices like these are well known in the art and are not pertinent to the invention. The system can also be written in several different languages and run on a number of different operating systems and platforms.

Although the present invention has been described in considerable detail with reference to certain preferred embodiments thereof, other embodiments are possible. Therefore, the point and scope of the appended claims should not be limited to the description of the preferred embodiments contained herein.

As to a further discussion of the manner of usage and operation of the present invention, the same should be apparent from the above description. Accordingly, no further discussion relating to the manner of usage and operation will be provided. Therefore, the foregoing is considered as illustrative only of the principles of the present invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.\

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for delivering an interactive game room experience, comprising:
providing an enclosed room with illuminated floor and wall tiles equipped with capacitive sensors,
providing an electronic device configured to control the illuminated floor and wall tiles and provide game information on connected displays;
the personal computer is connected to a switch that manages communication and control between controllers, receivers, and the active game LED floor;
the illuminated tiles change colors and respond dynamically to the players' proximity to enhance interactivity;
activating said tiles in response to players' proximity within one to two inches,
controlling the illuminated tiles with an electronic device connected to displays, switches, controllers, and receivers; and
the capacitive sensor powered illuminated floor and wall tiles delivering an interactive game room experience.

2. The method of claim 1, further comprising
monitoring the interaction of players with the tiles, tracking game progress, and providing real-time feedback and game information on connected displays to enhance the immersive experience.

3. The method of claim 1, further comprising
controlling the illuminated tiles with an electronic device is connected to one or more displays to provide game information such as levels, points, and player status.

4. The method of claim 3, further comprising
using the personal computer to manage communication and control between controllers, receivers, and the active game LED floor;
the active game LED floor comprises a plurality of LED tiles, each tile containing embedded sensors and RGB LED nodes for illumination; and
each LED tile is housed in a molded ABS plastic exterior with a 10 mm tempered glass top and is water-resistant in accordance with IP65 standards.

5. A method for operating an interactive game room, comprising:
providing an enclosed room with illuminated floor and wall tiles equipped with capacitive sensors,
a game engine system used for synchronized display and information feedback
between: the lighted tiles on the floors and wall of the game room,
visual displays to show messages and information related to the game state or various instructions related to the gameplay,
an audio system, and
additional input devices that affect or alter the gameplay;
controlling the tiles using a personal computer connected to displays, switches, controllers, and receivers,
monitoring the interaction of players with the tiles to track game progress and provide real-time feedback;
a computer-based system allowing tracking of scores associated with individual user and/or group/team profiles in a persistent manner;
configuring game levels and modes, tracking how many times each colored panel is triggered, and displaying gameplay results upon completion of the game session; and
displaying gameplay results, uploading gameplay data, and ending the gaming session once the game map rotation is completed or the gameplay time is up.

6. The method of claim 5, wherein the gameplay in an interactive game room, comprising:
starting a game session by requesting an account login,
loading account information if the login is provided, and
presenting a request to use in-game items if no login is provided.

7. The method of claim 6, further comprising
loading in-game items if available and presenting the ability to configure difficulty and game modes regardless of the availability of in-game items; and
the game levels and game modes are engaged once configured, and the gameplay begins with continuous monitoring of tile triggering events.

8. The method of claim 7, further comprising
adverse events are triggered upon an interaction with a specified, designated colored tile;
calculating adverse events versus success events when a tile is triggered during gameplay and determining if a success event is fulfilled;
adverse effects do not affect the final score; and
adverse effects are taken into account in the ranking or scoring.

9. The method of claim 8, further comprising
determining adverse events and success events'
processing those outcomes to the gameplay and outcome;
if an adverse event is determined, points are added to an adverse event pool;
if a success event is determined, points are added to a success event pool;
calculation of adverse events and success events continues until a game is over determination is made;
once a game over determination is made, all points in both the adverse event pool and success event pool are added up and final total points in both pools are displayed on a screen; and
the interactive game room experience ends.

10. The method of claim 9, wherein
a game session first defines yellow tile as an adverse event and green tiles as a success event;
if a player steps on two yellow tiles, the system registers the adverse event and counts two points in the adverse event pool;
if a player then steps on a green tile, the system registers the success event and counts one point in the success points pool;
the game ends and the system sums up the total points for the adverse events pool and success events pool; and
the adverse event points and the success event points are displayed on the screen/monitor.

11. The method of claim 8, wherein
triggering a specified, designated colored tile does not end the game or affect the gameplay even if players have used up all of their life points; and
a scheduled time slot to be dedicated to a booking party is completely used and available to them regardless of their skill level.

12. The method of claim 8, wherein
if a success event is not fulfilled, the system continues to monitor for tile triggering events until the gameplay time is up; and
if a success event is fulfilled, the system determines if a game map rotation is completed and engages the next game map if not completed, continuing the game until gameplay time is up.

13. The method of claim 5, further comprising
a game scoring algorithm to track player (individual or group) performance by tracking elements including:
sequential numbers of tiles with certain properties hit,
numbers of tiles with certain properties avoided,
numbers of tiles hit at a particular rate per unit of time, and
accounting for all of the aforementioned based on the number of players taking part in the game activity simultaneously.

14. The method of claim 13, wherein
the system tracking scores allows for progression of individual players and/or teams over time, based on their performance in the game sessions and the number of sessions they had participated in; and
the system tracking scores allows for tracking the number of distinct locations in which individual players and/or teams have participated in game sessions.

15. The method of claim 5, further comprising
a web and/or smartphone application to allow users to view their progression statistics and historical scores from a personal device; and
allow the users to register for future game sessions at specific locations.

16. The method of claim 5, further comprising
a progression system connected to an associated rewards system that offers digital and/or physical rewards to players and/or teams that had reached certain milestones in progression; and
the milestones include:
a certain total gameplay score over time,
a certain number of total sessions participated in, or
a certain number of total distinct gameplay locations visited for a game session;
the points scoring system and progression systems is used as inputs to a leaderboard system that allows individuals and/or groups/teams to compare their performance in individual game sessions and over time against the performance of others, including against their past selves and
the leaderboard system could also have associated digital and/or physical.

17. The method of claim 16, wherein
digital rewards include:
digital stickers which could be displayed in a “sticker book” in the system and these stickers could be traded with other players, and
digital “avatars” associated with the user's profile in the broader progression system.

18. The method of claim 16, wherein
physical rewards include branded merchandise provided by the game session location, and are exchangeable for “points” accrued by players over time according to an algorithm based on various factors including:
lifetime gameplay point score,
number of sessions,
number of group sessions,
total number of group session participants,
total number of physical gameplay locations visited, and
unlocked at various progression milestones and redeemed without needing to exchange “points”.

19. The method of claim 5, further comprising
a separate computer system to which game room operators connect their gameplay computer systems, in order to receive updated gameplay content, features, and game modes; and
the system allowing the distribution of new gameplay levels, new gameplay modes, new or updated scoring systems, and other game features such as new digital rewards for players to game room operators, to offer enhanced experience to players.
